(19) United States
(12) Patent Application Publication
(10) Pub. No.: US 2026/0333324 A1
(43) Pub. Date: Oct. 22, 2026

(54) COMMUNICATION METHOD, ELECTRONIC DEVICE, AND STORAGE MEDIUM

(71) Applicant: Beijing Xiaomi Mobile Software Co., LTD., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/122,462

(22) PCT Filed: Oct. 20, 2022
(86) PCT No.: PCT/CN2022/126501

§ 371 Date: Apr. 18, 2025

(51) Int. Cl. H04W 72/0453

(52) U.S. Cl. CPC H04W 72/0453

(57) ABSTRACT

Embodiments of the present disclosure relate to the technical field of mobile communications, and provide a communication method, an electronic device, and a storage medium. The communication method is applied to an access point device, and the method includes: determining a first radio frame, wherein the first radio frame includes first identification information, the first identification information indicates bandwidth information for transmission of each physical layer protocol data unit (PPDU) of an aggregated PPDU (A-PPDU) supported by an access point device, the PPDU being allocated by the access point device to a station device; and transmitting the first radio frame.

### CROSS-REFERENCE TO RELATED APPLICATION

The present application is a National Stage of International Application No. PCT/CN2022/126501, filed on Oct. 20, 2022, the entire disclosure of which is incorporated herein by reference for all purposes.

### TECHNICAL FIELD

The embodiments of the present disclosure relate to the field of mobile communication technology. Specifically, the embodiments of the present disclosure relate to a communication method, an electronic device and a storage medium.

### BACKGROUND

With the rapid development of mobile communication technology, wireless fidelity (Wi-Fi) technology has made great progress in transmission rate and throughput. At present, the research content of Wi-Fi technology, such as Ultra High Reliability (UHR), has the vision of improving the reliability of wireless local area network (WLAN) connection, reducing delay, improving manageability, increasing throughput at different signal to noise ratio (SNR) levels and reducing device-level power consumption. In addition, in UHR, in order to improve the throughput of the system, a manner of communicating simultaneously in sub 7 GHz (gigahertz) and 45 GHz and/or 60 GHz frequency bands is proposed.

In a multi-link scenario, the physical layer protocol data unit (PPDU) transmitted between the Access Point Multi-Link Device (AP MLD) and the Non-Access Point Multi-Link Device (Non-AP MLD) usually has an asymmetric operating bandwidth. In this case, in order to maximize the use of AP MLD capability, the aggregated PHY protocol data unit (A-PPDU) can be transmitted. Therefore, a mechanism to support A-PPDU transmission is required.

### SUMMARY

The embodiments of the present disclosure provide a communication method, an electronic device, and a storage medium.

On one hand, the embodiments of the present disclosure provide a communication method, which is applied to an access point device, the method includes:
determining a first radio frame, wherein the first radio frame includes first identification information, the first identification information indicates bandwidth information for transmission of each physical layer protocol data unit (PPDU) of an aggregated physical layer protocol data unit (A-PPDU) supported by the access point device, the PPDU is allocated by the access point device to a station device; and
sending the first radio frame.

On the other hand, the embodiments of the present disclosure further provide a communication method, which is applied to a station device, the method includes:
receiving a first radio frame, wherein the first radio frame includes first identification information, the first identification information indicates bandwidth information for transmission of each physical layer protocol data unit (PPDU) of an aggregated physical layer protocol data unit (A-PPDU) supported by the access point device, the PPDU is allocated by the access point device to each station device.

On the other hand, the embodiments of the present disclosure further provide an electronic device, the electronic device is an access point device, and the electronic device includes:
a determining module, configured to determine a first radio frame, wherein the first radio frame includes first identification information, the first identification information indicates bandwidth information for transmission of each physical layer protocol data unit (PPDU) of an aggregated physical layer protocol data unit (A-PPDU) supported by the access point device, the PPDU is allocated by the access point device to a station device; and
a sending module, configured to send the first radio frame.

On the other hand, the embodiments of the present disclosure further provide an electronic device, the electronic device is a station device, and the electronic device includes:
a receiving module, configured to receive a first radio frame, wherein the first radio frame includes first identification information, the first identification information indicates bandwidth information for transmission of each physical layer protocol data unit (PPDU) of an aggregated physical layer protocol data unit (A-PPDU) supported by the access point device, the PPDU is allocated by the access point device to each station device.

The embodiments of the present disclosure further provide an electronic device, including a memory, a processor, and computer programs stored in the memory and executable on the processor, wherein the processor implements one or more methods described in the embodiments of the present disclosure when executing the programs.

The embodiment of the present disclosure also provides a non-transitory computer-readable storage medium, having computer programs stored thereon, wherein when the computer programs are executed by a processor, the processor is caused to implement one or more methods described in the embodiments of the present disclosure.

In the embodiments of the present disclosure, a first radio frame is determined and sent, wherein the first radio frame includes first identification information, the first identification information indicates bandwidth information for transmission of each physical layer protocol data unit (PPDU) of an aggregated physical layer protocol data unit (A-PPDU) supported by the access point device, the PPDU is allocated by the access point device to a station device. The embodiments of the present disclosure provide a mechanism to support the A-PPDU transmission.

Additional aspects and advantages of the embodiment of the present disclosure will be partially given in the following description, which will become apparent from the following description or be understood through the practice of the present disclosure.

### BRIEF DESCRIPTION OF THE DRAWINGS

In order to more clearly illustrate the technical solutions in the embodiments of the present application, the following will briefly introduce the drawings required for the description of the embodiments. The drawings described below are only some embodiments of the present application. For ordinary technicians in this field, other drawings can be obtained based on these drawings without creative work.

FIG. 1 is one of the flow charts of the communication method provided by embodiments of the present disclosure;

FIG. 2 is one of the schematic diagrams of the first example of embodiments of the present disclosure;

FIG. 3 is another schematic diagram of the first example of embodiments of the present disclosure;

FIG. 4 is a schematic diagram of the second example of embodiments of the present disclosure;

FIG. 5 is another flow chart of the communication method provided by embodiments of the present disclosure;

FIG. 6 is one of the structural schematic diagrams of the electronic device provided by embodiments of the present disclosure;

FIG. 7 is another structural schematic diagram of the electronic device provided by embodiments of the present disclosure; and

FIG. 8 is still another structural schematic diagram of the electronic device provided by embodiments of the present disclosure.

### DETAILED DESCRIPTION

In the embodiments of the present disclosure, the term “and/or” describes the association relationship of the associated objects, indicating that there may be three relationships. For example, A and/or B can represent: A exists alone, A and B exist at the same time, and B exists alone. The character “/” generally indicates that the objects associated before and after are in an “or” relationship.

In the embodiments of the present disclosure, the term “a plurality of” refers to two or more, and other quantifiers are similar.

Here, the example embodiments will be described in detail, and examples thereof are shown in the accompanying drawings. Unless otherwise indicated, when the following description refers to the drawings, the same number in different drawings represents the same or similar elements. The implementations described in the following example embodiments do not represent all implementations consistent with the present disclosure. Instead, they are merely examples of apparatuses and methods consistent with some aspects of the present disclosure as detailed in the appending claims.

The terms used in the present disclosure are for the purpose of describing specific embodiments only and are not intended to limit the present disclosure. The singular forms “a”, “said” and “the” used in the present disclosure and the appending claims are also intended to include the plural forms, unless the context clearly indicates otherwise. It should also be understood that the term “and/or” used herein refers to and includes any or all possible combinations of one or more associated listed items.

It should be understood that, although the terms first, second, third, etc. may be used in the present disclosure to describe various information, these information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the word “if” used herein may be interpreted as “at . . . ” or “when . . . ” or “in response to determining that”.

The technical solutions in the embodiments of the present disclosure will be clearly and completely described below in conjunction with the drawings in the embodiments of the present disclosure. The described embodiments are only a part of the embodiments of the present disclosure, not all of the embodiments. Based on the embodiments in the present disclosure, all other embodiments obtained by ordinary technicians in the field without making creative work are within the scope of protection of the present disclosure.

The embodiments of the present disclosure provide a communication method, an electronic device and a storage medium, to provide a mechanism to support the A-PPDU transmission.

The method and the apparatus are based on the same application concept. Since the principles of solving the problem of the method and the apparatus are similar, the implementation of the apparatus and the method can refer to each other, and the repeated parts will not be repeated.

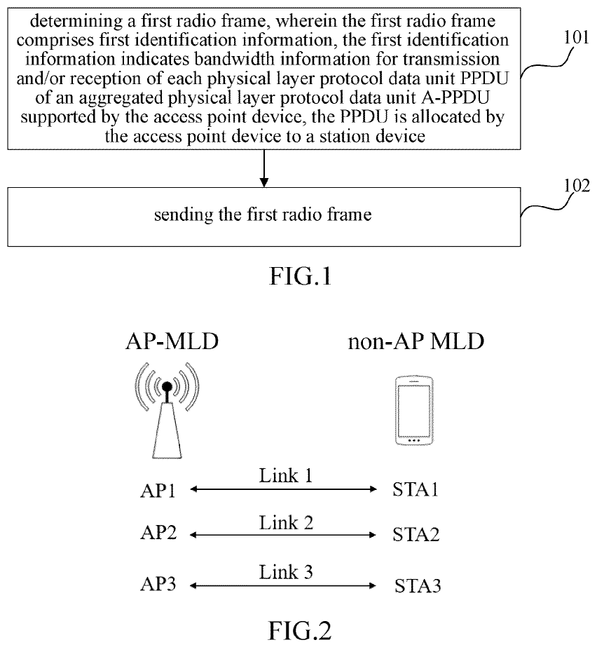

As shown in FIG. 1, the embodiment of the present disclosure provides a communication method. Optionally, the method can be applied to an access point (AP) device, and the method may include the following steps.

Step 101, a first radio frame is determined, wherein the first radio frame includes first identification information, the first identification information indicates bandwidth information for transmission of each physical layer protocol data unit PPDU of an aggregated physical layer protocol data unit A-PPDU supported by the access point device, the PPDU is allocated by the access point device to a station device.

In a wireless local area network, a basic service set (BSS) can be composed of an AP and one or more stations (STA) communicating with the AP. A basic service set can be connected to a distribution system (DS) through its AP, and then connected to another basic service set, to form an extended service set (ESS).

Optionally, the AP is, for example, a device with a wireless-to-wired bridging function, and the AP is responsible for extending the services provided by the wired network to the wireless network. The STA is, for example, an electronic device with a wireless network access function, and provides a frame delivery service to allow information to be transmitted.

In the embodiments of the present disclosure, the AP and the STA may be devices that support multi-link, for example, they may be represented as AP MLD and non-AP MLD, respectively. For ease of description, the following mainly describes an example in which an AP communicates with a STA under multi-link, however, the example embodiments of the present disclosure are not limited thereto.

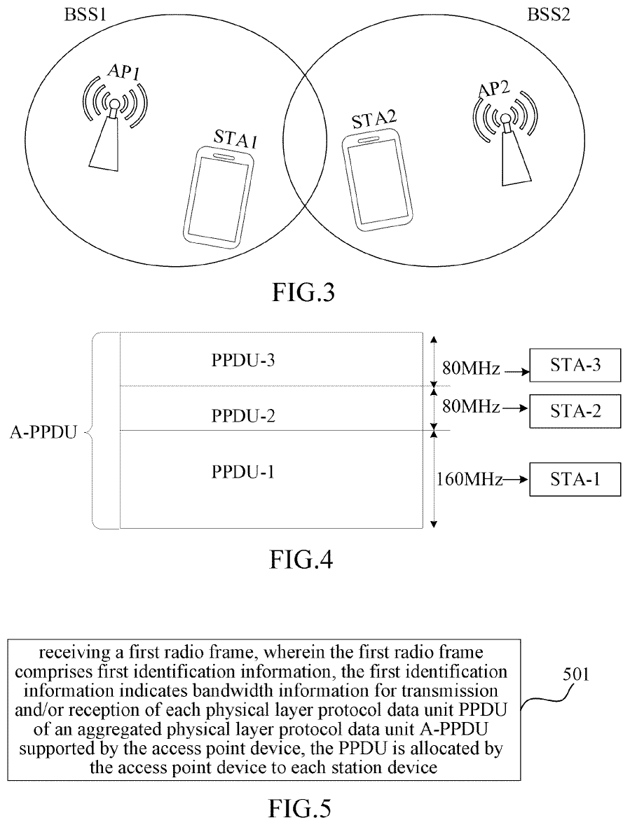

As a first example, referring to FIG. 2 and FIG. 3, the AP MLD may represent an access point that supports the multi-link communication function, and the non-AP MLD may represent a station that supports the multi-link communication function.

Referring to FIG. 2, the AP MLD may include three subordinates APs, such as AP1, AP2, and AP3 as shown in FIG. 2. Each AP may work in link 1, link 2, and link 3, respectively. The non-AP MLD may also include three subordinates STAs, such as STA1, STA2, and STA3 as shown in FIG. 2. STA1 works in link 1, STA2 works in link 2, and STA3 works in link 3. In the example of FIG. 3, it is assumed that AP1 communicates with STA1 through the corresponding first link Link 1, similarly, AP2 communicates with STA2 through the corresponding second link Link 2, and AP3 communicates with STA3 through the third link Link 3. In addition, Link 1 to Link 3 may be multiple links at different frequencies, for example, links at 2.4 GHz, 5 GHZ, and 6 GHz, or several links of the same or different bandwidths at 2.4 GHz. In addition, a plurality of channels may exist under each link. It may be understood that, the communication scenario shown in FIG. 2 is only an example, and the concept of the present disclosure is not limited thereto. For example, the AP MLD may be connected to a plurality of (three) non-AP MLDs, alternatively, under each link, the AP may communicate with a plurality of stations of other types.

Generally, the maximum operating bandwidths that the AP MLD and some of the non-AP MLDs associated with it can support are different. For example, the AP MLD may support a maximum operating bandwidth of 320 MHz or 640 MHz, while some non-AP MLDs associated with the AP MLD may only support a maximum operating bandwidth of 160 MHz or 80 MHz, or less. That is, the PPDU transmitted in AP MLD and non-AP MLD has an asymmetric operating bandwidth. In this case, in order to maximize the use of AP MLD capability and improve the system throughput, A-PPDU can be transmitted.

In the embodiments of the present disclosure, the first radio frame includes, for example, a beacon frame and/or a probe response frame, and the AP establishes an initial association with the STA through the first radio frame, to transmit the radio frame to the STA.

The AP carries the first identification information in the first radio frame, and the first identification information indicates the bandwidth information for transmission of each physical layer protocol data unit PPDU of the aggregated physical layer protocol data unit A-PPDU supported by the access point device. The A-PPDU includes a plurality of PPDUs, each PPDU may have a different bandwidth, which is equivalent to that the A-PPDU serves as a PPDU combination, and the first identification information indicates the bandwidth of each PPDU in the PPDU combination. As a second example, as shown in FIG. 4, the A-PPDU includes three PPDUs. PPDU-1 has a bandwidth of 160 MHz, and its receiving end can be STA1, PPDU-2 has a bandwidth of 80 MHz, and its receiving end can be STA2, and PPDU-3 has a bandwidth of 80 MHz, and its receiving end can be STA3. The first identification information can identify the bandwidth information of the three PPDUs respectively, and also identify that the receiving ends of different PPDUs are different STAs.

The bandwidth of each PPDU of the A-PPDU may be determined according to the maximum bandwidth supported by the AP. For example, in the 6 GHz spectrum, when the AP supports a maximum bandwidth of 320 MHz, the bandwidth combinations for uplink and downlink reception of PPDU in the A-PPDU supported by the AP may include: (1) 80 MHz+80 MHz+160 MHz; (2) 80 MHz+80 MHz+80 MHz+80 MHz; (3) 160 MHz+160 MHz. Alternatively, in the 6 GHz spectrum, when the AP supports a maximum of 640 MHz, the bandwidth combinations for uplink and downlink reception of PPDU in the A-PPDU supported by the AP may include: (1) 8*80 MHz (2) 4*160 MHz (3) 2*320 MHz (4) 320+2*160 (5)3*160 MHz+2*80MHz (6) 2*160 MHz+4*80 MHz (7) 160 MHz+3*160 combinations, where “*” represents a multiplication sign. Some of the above combinations may also exist in the 5 GHz spectrum.

The PPDU is allocated by the access point device to the station device, for example, a PPDU is allocated to each STA, and the bandwidth of the allocated PPDU is greater than or equal to the maximum operating bandwidth of the corresponding STA.

Step 102, the first radio frame is sent.

For example, the first radio frame can be sent to the STA through any of the multiple links in FIG. 3, such that the STA can obtain the bandwidth information of each PPDU of the A-PPDU. For example, the target PPDU allocated by the AP to the STA is determined according to the bandwidth information of each PPDU, the target PPDU is received, and then the transmission of the A-PPDU is achieved.

In the embodiments of the present disclosure, a first radio frame is determined and sent, wherein the first radio frame includes first identification information, the first identification information indicates bandwidth information for transmission of each physical layer protocol data unit PPDU of an aggregated physical layer protocol data unit A-PPDU supported by the access point device, the PPDU is allocated by the access point device to a station device. The embodiments of the present disclosure provide a mechanism to support the A-PPDU transmission.

The embodiments of the present disclosure provide a communication method, which can be applied to an access point device, and the method can include the following steps:
determining a first radio frame, wherein the first radio frame includes first identification information, the first identification information indicates bandwidth information for transmission of each physical layer protocol data unit PPDU of an aggregated physical layer protocol data unit A-PPDU supported by the access point device, the PPDU is allocated by the access point device to a station device, wherein the first radio frame further includes bandwidth identification information, the bandwidth identification information indicates a maximum operating bandwidth of the access point device; and
sending the first radio frame.

The first radio frame further includes bandwidth identification information, the bandwidth identification information indicates a maximum operating bandwidth of the access point device, such as the maximum operating bandwidth under different frequency bands, such that the STA can obtain the bandwidth capability information of the AP.

Optionally, the bandwidth identification information is carried in an ultra high reliability UHR operation capability information element of the first radio frame.

In the embodiments of the present disclosure, the method further includes the following steps:
receiving a second radio frame sent by the station device, wherein the second radio frame includes second identification information, the second identification information indicates the maximum operating bandwidth or an available operating bandwidth supported by the station device;
allocating the PPDU to the station device according to the second identification information, wherein a coverage bandwidth of allocating the PPDU to the station device is greater than or equal to the maximum operating bandwidth supported by the station device.

Optionally, the second radio frame includes, for example, an association request frame and/or a probe request frame. For example, the STA sends a second radio frame to initially associate with the access point device, and indicates the maximum operating bandwidth or available operating bandwidth supported by the station device through the second identification information, that is, the bandwidth capability information of the STA is indicated through the second identification information. The bandwidth capability information includes the maximum operating bandwidth or the available operating bandwidth. For example, if the STA supports a maximum operating bandwidth of 160 MHz, then it supports configuring the PPDU in the A-PPDU with a bandwidth of 160 MHz, or two 80 MHz, then the available operating bandwidth includes 160 MHz and 80 MHz.

The AP allocates PPDU (or allocates the bandwidth of PPDU) to each STA based on its own maximum operating bandwidth and the maximum operating bandwidth of each STA, ensuring that the sum of the coverage bandwidths of all PPDUs allocated to one STA (the coverage bandwidth is the sum of bandwidths of all PPDU allocated to the STA) is greater than or equal to the maximum operating bandwidth supported by the station device, such that the bandwidth of the PPDU allocated to the STA can cover the maximum operating bandwidth of the STA.

In the embodiments of the present disclosure, a first radio frame is determined and sent, wherein the first radio frame includes first identification information, the first identification information indicates bandwidth information for transmission of each physical layer protocol data unit PPDU of an aggregated physical layer protocol data unit A-PPDU supported by the access point device, the PPDU is allocated by the access point device to a station device. The embodiments of the present disclosure provide a mechanism to support the A-PPDU transmission.

Referring to FIG. 5, the embodiments of the present disclosure provide a communication method. Optionally, the method can be applied to STA, STA is, for example, an electronic device with a wireless network access function, such as a device that provides voice and/or data connectivity to a user, a handheld device with a wireless connection function, or other processing devices connected to a wireless modem.

The method may include the following step:
step 501, receiving a first radio frame, wherein the first radio frame includes first identification information, the first identification information indicates bandwidth information for transmission of each physical layer protocol data unit PPDU of an aggregated physical layer protocol data unit A-PPDU supported by the access point device, the PPDU is allocated by the access point device to each station device.

The architecture of the WLAN applied to the communication method provided in the embodiments of the present disclosure refers to the aforementioned first example, which will not be repeated here.

Generally, the maximum operating bandwidths that the AP MLD and some of the non-AP MLDs associated with it can support are different. For example, the AP MLD may support a maximum operating bandwidth of 320 MHz or 640 MHz, while some non-AP MLDs associated with the AP MLD may only support a maximum operating bandwidth of 160 MHz or 80 MHz, or less. That is, the PPDU transmitted in AP MLD and non-AP MLD has an asymmetric operating bandwidth. In this case, in order to maximize the use of AP MLD capability and improve the system throughput, A-PPDU can be transmitted.

In the embodiment of the present disclosure, the first radio frame includes, for example, a beacon frame and/or a probe response frame, and the AP establishes an initial association with the STA through the first radio frame, to transmit the radio frame to the STA.

The STA obtains the first identification information carried in the first radio frame, and determines the bandwidth information for transmission of each physical layer protocol data unit PPDU of the aggregated physical layer protocol data unit A-PPDU supported by the access point device according to the first identification information. The A-PPDU includes a plurality of PPDUs, each PPDU may have a different bandwidth, which is equivalent to that the A-PPDU serves as a PPDU combination, and the first identification information indicates the bandwidth of each PPDU in the PPDU combination. Referring to a second example, as shown in FIG. 4, the A-PPDU includes three PPDUs. PPDU-1 has a bandwidth of 160 MHz, PPDU-2 has a bandwidth of 80 MHz, PPDU-3 has a bandwidth of 80 MHz, the first identification information can identify the bandwidth information of the three PPDUs respectively.

The bandwidth of each PPDU of the A-PPDU may be determined according to the maximum bandwidth supported by the AP. For example, when the AP supports a maximum bandwidth of 320 MHz, the bandwidth combinations for uplink and downlink reception of PPDU in the A-PPDU supported by the AP may include: (1) 80 MHz+80 MHz+160 MHz; (2) 80 MHz +80 MHz+80 MHz+80 MHz; (3) 160 MHz+160 MHz. Alternatively, when the AP supports a maximum of 640 MHz, the bandwidth combinations for uplink and downlink reception of PPDU in the A-PPDU supported by the AP may include: (1) 8*80 MHz (2) 4*160 MHZ (3) 2*320 MHZ (4) 320+2*160 (5) 3*160 MHz+2*80 MHz (6) 2*160 MHz+4*80 MHz (7) 160 MHz+3*160combinations, where “*” represents a multiplication sign.

The PPDU is allocated by the access point device to the station device, for example, a PPDU is allocated to each STA, and the bandwidth of the allocated PPDU is greater than or equal to the maximum operating bandwidth of the corresponding STA.

For example, the STA can receive the first radio frame sent by the AP through any of the multiple links in FIG. 3, obtain the bandwidth information of each PPDU of the A-PPDU. For example, the target PPDU allocated by the AP to the STA is determined according to the bandwidth information of each PPDU, the target PPDU is received, and then the transmission of the A-PPDU is achieved.

In the embodiments of the present disclosure, the STA receives a first radio frame, wherein the first radio frame includes first identification information, the first identification information indicates bandwidth information for transmission of each physical layer protocol data unit PPDU of an aggregated physical layer protocol data unit A-PPDU supported by the access point device, the PPDU is allocated by the access point device to each station device. The embodiment of the present disclosure provides a mechanism to support the transmission of A-PPDU.

In the embodiment of the present disclosure, the method further includes the following steps:
determining a second radio frame, wherein the second radio frame includes second identification information, the second identification information indicates a maximum operating bandwidth or an available operating bandwidth supported by the station device; and
sending the second radio frame.

Optionally, the second radio frame includes, for example, an association request frame and/or a probe request frame. For example, the STA sends a second radio frame to initially associate with the access point device, and indicates the maximum operating bandwidth or available operating bandwidth supported by the station device through the second identification information, that is, the bandwidth capability information of the STA is indicated through the second identification information. The bandwidth capability information includes the maximum operating bandwidth or the available operating bandwidth. For example, if the STA supports a maximum operating bandwidth of 160 MHz, then it supports configuring the PPDU in the A-PPDU with a bandwidth of 160 MHz, or two 80 MHz, then the available operating bandwidth includes 160 MHz and 80 MHz.

In this way, the AP allocates PPDU (or allocates the bandwidth of PPDU) to each STA based on its own maximum operating bandwidth and the maximum operating bandwidth of each STA, ensuring that the sum of the coverage bandwidths of all PPDUs allocated to one STA (the coverage bandwidth is the sum of bandwidths of all PPDU allocated to the STA) is greater than or equal to the maximum operating bandwidth supported by the station device, such that the bandwidth of the PPDU allocated to the STA can cover the maximum operating bandwidth of the STA.

In the embodiments of the present disclosure, the method further includes the following steps:
determining a second radio frame, wherein the second radio frame includes second identification information, the second identification information indicates an available operating bandwidth supported by the station device, the second identification information includes identification sub-information corresponding to each preset operating bandwidth, the identification sub-information indicates whether the preset operating bandwidth is available, and an operating bandwidth available to the station device is the available operating bandwidth; and
sending the second radio frame.

Optionally, the second radio frame includes, for example, an association request frame and/or a probe request frame. For example, the STA sends a second radio frame to initially associate with the access point device, and indicates the available operating bandwidth supported by the station device through the second identification information, that is, the bandwidth capability information of the STA is indicated through the second identification information.

The second identification information includes identification sub-information corresponding to each preset operating bandwidth, the identification sub-information indicates whether the preset operating bandwidth is available, and an operating bandwidth available to the station device is the available operating bandwidth. The station device may include a plurality of preset operating bandwidths, such as 80 MHz, 160 MHz, 320 MHz, etc. One identification sub-information may be set for each preset operating bandwidth, and the identification sub-information is used to identify whether the corresponding preset operating bandwidth is an operating bandwidth available for the station device. For example, the identification sub-information is a bit, and setting it to “1” indicates that the corresponding bandwidth is available, and setting it to “0” indicates that the corresponding bandwidth is unavailable.

Optionally, the second identification information is carried in an ultra high reliability UHR operation capability information element of the second radio frame.

In the embodiments of the present disclosure, the method further includes the following steps:
determining a second radio frame, wherein the second radio frame includes second identification information, the second identification information indicates a maximum operating bandwidth or an available operating bandwidth supported by the station device, wherein the second radio frame further includes capability identification information, the capability identification information indicates that the station device supports receiving the aggregated physical layer protocol data unit A-PPDU; and
sending the second radio frame.

Optionally, the second radio frame includes, for example, an association request frame and/or a probe request frame. For example, the STA sends a second radio frame to initially associate with the access point device, and indicates that the station device supports receiving A-PPDU through capability identification information, such that the AP acquires the capability information of the STA supporting receiving A-PPDU, and allocates PPDU (or allocates bandwidth of PPDU) to the STA according to the capability information of the STA.

In the embodiment of the present disclosure, the STA receives a first radio frame, wherein the first radio frame includes first identification information, the first identification information indicates bandwidth information for transmission of each physical layer protocol data unit PPDU of an aggregated physical layer protocol data unit A-PPDU supported by the access point device, the PPDU is allocated by the access point device to each station device. The embodiment of the present disclosure provides a mechanism to support the transmission of A-PPDU.

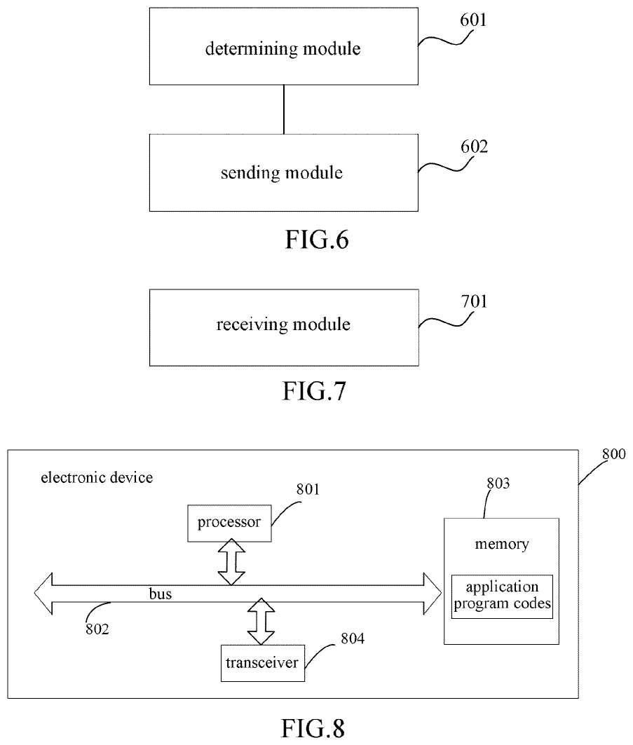

Referring to FIG. 6, based on the same principle as the method provided in the embodiments of the present disclosure, the embodiments of the present disclosure further provide an electronic device, the electronic device is an access point device, the electronic device includes:
a determining module 601, configured to determine a first radio frame, wherein the first radio frame includes first identification information, the first identification information indicates bandwidth information for transmission of each physical layer protocol data unit PPDU of an aggregated physical layer protocol data unit A-PPDU supported by the access point device, the PPDU is allocated by the access point device to a station device; and
a sending module 602, configured to send the first radio frame.

Optionally, in the embodiments of the present disclosure, the first radio frame further includes bandwidth identification information, the bandwidth identification information indicates a maximum operating bandwidth of the access point device.

Optionally, in the embodiments of the present disclosure, the bandwidth identification information is carried in an ultra high reliability UHR operation capability information element of the first radio frame.

Optionally, in the embodiments of the present disclosure, the electronic device further includes:
an allocation module, used to receive a second radio frame sent by the station device, wherein the second radio frame includes second identification information, the second identification information indicates the maximum operating bandwidth or an available operating bandwidth supported by the station device;
allocate the PPDU to the station device according to the second identification information, wherein a coverage bandwidth of allocating the PPDU to the station device is greater than or equal to the maximum operating bandwidth supported by the station device.

Optionally, in the embodiments of the present disclosure, the first radio frame includes a beacon frame and/or a probe response frame.

The embodiments of the present disclosure also provide a communication apparatus, which is applied to an access point device, and the apparatus includes:
a radio frame determination module, used to determine a first radio frame, wherein the first radio frame includes first identification information, the first identification information indicates bandwidth information for transmission of each physical layer protocol data unit PPDU of an aggregated physical layer protocol data unit A-PPDU supported by the access point device, the PPDU is allocated by the access point device to a station device; and
a radio frame sending module, used to send the first radio frame.

The apparatus also includes other modules of the electronic device in the aforementioned embodiments, which will not be repeated here.

Referring to FIG. 7, based on the same principle as the method provided in the embodiments of the present disclosure, the embodiments of the present disclosure further provide an electronic device, the electronic device is an access point device, the electronic device includes:
a receiving module 701, configured to receive a first radio frame, wherein the first radio frame includes first identification information, the first identification information indicates bandwidth information for transmission of each physical layer protocol data unit PPDU of an aggregated physical layer protocol data unit A-PPDU supported by the access point device, the PPDU is allocated by the access point device to each station device.

Optionally, in the embodiment of the present disclosure, the electronic device further includes:
a processing module, configured to determine a second radio frame, wherein the second radio frame includes second identification information, the second identification information indicates a maximum operating bandwidth or an available operating bandwidth supported by the station device; and
send the second radio frame.

Optionally, in the embodiments of the present disclosure, the second identification information includes identification sub-information corresponding to each preset operating bandwidth, the identification sub-information indicates whether the preset operating bandwidth is available, and an operating bandwidth available to the station device is the available operating bandwidth.

Optionally, in the embodiments of the present disclosure, the second identification information is carried in an ultra high reliability UHR operation capability information element of the second radio frame.

Optionally, in the embodiments of the present disclosure, the second radio frame further includes capability identification information, the capability identification information indicates that the station device supports receiving the aggregated physical layer protocol data unit A-PPDU.

Optionally, in the embodiments of the present disclosure, the second radio frame includes an association request frame and/or a probe request frame.

The present disclosure embodiment also provides a communication apparatus, which is applied to a station device, and the apparatus includes:
a radio frame receiving module, used to receive a first radio frame, wherein the first radio frame includes first identification information, the first identification information indicates bandwidth information for transmission of each physical layer protocol data unit PPDU of an aggregated physical layer protocol data unit A-PPDU supported by the access point device, the PPDU is allocated by the access point device to each station device.

The apparatus also includes other modules of the electronic device in the aforementioned embodiments, which will not be repeated here.

In an optional embodiment, the embodiments of the present disclosure also provide an electronic device, as shown in FIG. 8, the electronic device 800 shown in FIG. 8 can be a server, including: a processor 801 and a memory 803. The processor 801 and the memory 803 are connected, such as through a bus 802. Optionally, the electronic device 800 may also include a transceiver 804. It should be noted that in actual applications, the transceiver 804 is not limited to one, and the structure of the electronic device 800 does not constitute a limitation on the embodiments of the present disclosure.

The processor 801 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components or any combination thereof. It can implement or execute various example logic blocks, modules and circuits described in conjunction with contents disclosed by the present disclosure. The processor 801 may also be a combination that implements computing functions, such as a combination of one or more microprocessors, a combination of DSPs and microprocessors, etc.

The bus 802 may include a path to transmit information between the above components. The bus 802 may be a PCI (Peripheral Component Interconnect) bus or an EISA (Extended Industry Standard Architecture) bus, etc. The bus 802 may be divided into an address bus, a data bus, a control bus, etc. For ease of representation, only one thick line is used in FIG. 8, but it does not mean that there is only one bus or one type of bus.

The memory 803 may be a ROM (Read Only Memory) or other types of static storage devices that can store static information and instructions, a RAM (Random Access Memory) or other types of dynamic storage devices that can store information and instructions, or an EEPROM (Electrically Erasable Programmable Read Only Memory), a CD-ROM (Compact Disc Read Only Memory) or other compact disk storage, optical disk storage (including compressed optical disk, laser disk, optical disk, digital versatile disk, Blu-ray disk, etc.), a disk storage medium or other magnetic storage devices, or any other medium that can be used to carry or store the desired program codes in the form of instructions or data structures and can be accessed by a computer, but is not limited thereto.

The memory 803 is used to store the application program codes for executing the disclosed solution, and is controlled by the processor 801 to execute. The processor 801 is used to execute the application program codes stored in the memory 803 to implement the contents shown in the above method embodiments.

The electronic device includes but is not limited to: mobile terminals such as mobile phones, laptops, digital broadcast receivers, PDAs (personal digital assistants), PADs (tablet computers), PMPs (portable multimedia players), vehicle-mounted terminals (such as vehicle-mounted navigation terminals), etc., and fixed terminals such as digital TVs, desktop computers, etc. The electronic device shown in FIG. 8 is only an example and should not impose any restriction on the functions and scope of use of embodiments of the present disclosure.

The server provided in the present disclosure can be a standalone physical server, or a server cluster or distributed system composed of a plurality of physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal can be a smart phone, a tablet computer, a laptop computer, a desktop computer, a smart speaker, a smart watch, etc., but is not limited thereto. The terminal and the server can be directly or indirectly connected via wired or wireless communication, which is not limited in the present disclosure.

The embodiment of the present disclosure provides a computer-readable storage medium, and a computer program is stored thereon. When the computer program is run on a computer, the computer can execute the corresponding contents in the aforementioned method embodiments.

It should be understood that, although the steps in the flowchart of the drawings are displayed in sequence as indicated by the arrows, these steps are not necessarily executed in the order indicated by the arrows. Unless otherwise specified in this document, there is no strict order restriction for the execution of these steps, and they can be executed in other orders. Moreover, at least part of the steps in the flowchart of the drawings may include a plurality of sub-steps or a plurality of stages, and these sub-steps or stages are not necessarily executed at the same time, but can be executed at different times, and their execution order is not necessarily sequential, but can be executed in turn or alternately with other steps or at least part of the sub-steps or stages of other steps.

It should be noted that the above-mentioned computer-readable medium of the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus or device, or any combination of the above. More specific examples of computer-readable storage media may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in conjunction with an instruction execution system, apparatus, or device. In the present disclosure, a computer-readable signal medium may include a data signal propagated in a baseband or as part of a carrier wave, which carries computer-readable program codes. Such propagated data signals may take a variety of forms, including but not limited to electromagnetic signals, optical signals, or any suitable combination of the above. A computer-readable signal medium may also be any computer-readable medium other than a computer-readable storage medium, and the computer-readable signal medium may send, propagate, or transmit a program for use by or in conjunction with an instruction execution system, apparatus, or device. The program codes contained on a computer-readable medium may be transmitted using any appropriate medium, including but not limited to: wires, optical cables, RF (radio frequency), etc., or any suitable combination of the above.

The above-mentioned computer-readable medium may be included in the above-mentioned electronic device; or it may exist independently without being assembled into the electronic device.

The above-mentioned computer-readable medium carries one or more programs. When the above-mentioned one or more programs are executed by the electronic device, the electronic device executes the methods shown in the above-mentioned embodiments.

According to one aspect of the present disclosure, a computer program product or computer program is provided, and the computer program product or computer program includes computer instructions, and the computer instructions are stored in a computer-readable storage medium. The processor of the computer device reads the computer instructions from the computer-readable storage medium, and the processor executes the computer instructions, such that the computer device executes the methods provided in the above-mentioned various optional implementations.

The computer program codes for performing the operations of the present disclosure can be written in one or more programming languages or a combination thereof, and the above-mentioned programming languages include object-oriented programming languages—such as Java, Smalltalk, C++, and also include conventional procedural programming languages—such as “C” language or similar programming languages. The program codes can be executed completely on the user's computer, partially on the user's computer, executed as an independent software package, executed partially on the user's computer and partially on a remote computer, or executed completely on a remote computer or server. In cases involving a remote computer, the remote computer may be connected to the user computer through any type of network, including a local area network (LAN) or a wide area network (WAN), or may be connected to an external computer (e.g., through the Internet using an Internet service provider).

The flowcharts and block diagrams in the accompanying drawings illustrate the possible architectures, functions, and operations of the systems, methods, and computer program products according to various embodiments of the present disclosure. In this regard, each box in the flowchart or block diagram may represent a module, a program segment, or a portion of a code, which contains one or more executable instructions for implementing the specified logical functions. It should also be noted that in some alternative implementations, the functions marked in the box may also occur in an order different from that marked in the accompanying drawings. For example, two boxes represented in succession may actually be executed substantially in parallel, and they may sometimes be executed in the opposite order, depending on the functions involved. It should also be noted that, each box in the block diagram and/or flowchart, and the combination of boxes in the block diagram and/or flowchart, can be implemented by a dedicated hardware-based system that performs the specified function or operation, or can be implemented by a combination of dedicated hardware and computer instructions.

The modules involved in the embodiments described in the present disclosure can be implemented by software or by hardware. The name of the module does not constitute a limitation on the module itself in some cases. For example, module A can also be described as “module A for performing operation B”.

The above description is only a preferred embodiment of the present disclosure and an explanation of the used technical principles. Those skilled in the art should understand that the scope of disclosure involved in the present disclosure is not limited to the technical solutions formed by a specific combination of the above technical features, but also should cover other technical solutions formed by any combination of the above technical features or their equivalent features without departing from the above concept of the present disclosure, for example, the technical solutions formed by replacing the above features with the technical features with similar functions disclosed in the present disclosure (but not limited to).

1. A communication method, performed by an access point device, the method comprising:
determining a first radio frame, wherein the first radio frame comprises first identification information, the first identification information indicates bandwidth information for transmission of each physical layer protocol data unit (PPDU) of an aggregated physical layer protocol data unit (A-PPDU) supported by the access point device, the PPDU is allocated by the access point device to a station device; and
sending the first radio frame.

2. The communication method according to claim 1, wherein the first radio frame further comprises bandwidth identification information, the bandwidth identification information indicates a maximum operating bandwidth of the access point device.

3. The communication method according to claim 2, wherein the bandwidth identification information is carried in an ultra high reliability (UHR) operation capability information element of the first radio frame.

4. The communication method according to claim 3, further comprising:
receiving a second radio frame sent by the station device, wherein the second radio frame comprises second identification information, the second identification information indicates the maximum operating bandwidth or an available operating bandwidth supported by the station device;
allocating the PPDU to the station device according to the second identification information, wherein a coverage bandwidth of allocating the PPDU to the station device is greater than or equal to the maximum operating bandwidth supported by the station device.

5. The communication method according to claim 1, wherein the first radio frame comprises at least one of a beacon frame or a probe response frame.

6. A communication method, performed by a station device, the method comprising:
receiving a first radio frame, wherein the first radio frame comprises first identification information, the first identification information indicates bandwidth information for transmission of each physical layer protocol data unit (PPDU) of an aggregated physical layer protocol data unit (A-PPDU) supported by the access point device, the PPDU is allocated by the access point device to each station device.

7. The communication method according to claim 6, further comprising:
determining a second radio frame, wherein the second radio frame comprises second identification information, the second identification information indicates a maximum operating bandwidth or an available operating bandwidth supported by the station device; and
sending the second radio frame.

8. The communication method according to claim 7, wherein
the second identification information comprises identification sub-information corresponding to each preset operating bandwidth, the identification sub-information indicates whether the preset operating bandwidth is available, and an operating bandwidth available to the station device is the available operating bandwidth.

9. The communication method according to claim 7, wherein the second identification information is carried in an ultra high reliability (UHR) operation capability information element of the second radio frame.

10. The communication method according to claim 7, wherein the second radio frame further comprises capability identification information, the capability identification information indicates that the station device supports receiving the aggregated physical layer protocol data unit (A-PPDU).

11. The communication method according to claim 7, wherein the second radio frame comprises at least one of an association request frame or a probe request frame.

12.-13. (canceled)

14. An electronic device, comprising a memory, a processor, and computer programs stored in the memory and executable on the processor, wherein the processor implements a communication method when executing the programs, wherein the method is performed by an access point device, and the processor is configured to:
determine a first radio frame, wherein the first radio frame comprises first identification information, the first identification information indicates bandwidth information for transmission of each physical layer protocol data unit (PPDU) of an aggregated physical layer protocol data unit (A-PPDU) supported by the access point device, the PPDU is allocated by the access point device to a station device; and
send the first radio frame.

15. A non-transitory computer-readable storage medium, having computer programs stored thereon, wherein when the computer programs are executed by a processor, the processor is caused to implement the method according to claim 1.

16. An electronic device, comprising a memory, a processor, and computer programs stored in the memory and executable on the processor, wherein the processor implements the method according claim 6 when executing the programs.

17. A non-transitory computer-readable storage medium, having computer programs stored thereon, wherein when the computer programs are executed by a processor, the processor is caused to implement the method according to claim 6.
